(19) United States
(12) Patent Application Publication
(10) Pub. No.: US 2025/0143215 A1
(43) Pub. Date: May 8, 2025

(54) METHOD FOR FIELD WORKING

(71) Applicant: MASCHINENFABRIK BERNARD KRONE GMBH & CO. KG, SPELLE (DE)

(72) Inventors: BERND JOHANNING, MELLE (DE); ANDREJ BAISER, OSNABRUECK (DE)

(73) Assignee: MASCHINENFABRIK BERNARD KRONE GMBH & CO. KG, SPELLE (DE)

(21) Appl. No.: 18/931,082

(22) Filed: Oct. 30, 2024

(30) Foreign Application Priority Data
Nov. 3, 2023 (DE) 10 2023 130 420.8

(51) Int. Cl. A01D 43/10; A01D 78/00

(52) U.S. Cl. CPC A01D 43/10; A01D 78/007

(57) ABSTRACT

A method for field processing includes mowing, via a mowing machine having at least one mower, a crop within a processing area so as to provide a mown crop. At least one mowing parameter is determined for each position of a plurality of positions within the processing area. The at least one mowing parameter has a mower parameter which relates to the at least one mower and which is associated with an area density of the crop. The mown crop is processed via a cropmaking machine which has at least one processing device. At least one cropmaking parameter which characterizes an operation of the cropmaking machine is set as a function of a position of the cropmaking machine. The at least one mowing parameter is determined for the position

### CROSS REFERENCE TO PRIOR APPLICATIONS

Priority is claimed to German Patent Application No. DE 10 2023 130 420.8, filed Nov. 3, 2023. The entire disclosure of said application is incorporated by reference herein.

### FIELD

The present invention relates to a method for field processing.

### BACKGROUND

Stalks such as grass are usually harvested and processed in several stages. The stalks are first mowed with a mowing machine, which can also carry out processing to partially remove or break up the moisture-insulating wax film of the plant parts. This is typically followed by processing with a cropmaking machine, for example, a tedder or swather, whereby the stalks remain in the field but are moved and/or turned. The stalks can be distributed on the field for better drying; it is also possible to fold the distributed stalks into a windrow in preparation for later collection. The stalks can lastly be collected and processed, for example, into crop bales.

Stalks or other crops can in principle be present in different area densities, i.e., there can be a different mass of crop per unit area. This depends on various factors, for example, the plant species contained, the average distance between the individual plants, their size, a weather-dependent moisture content, and other factors. A rough distinction can be made between “light” and “heavy” crops. Different settings of the agricultural machines used are advantageous depending on the area density. This applies, for example, to the cropmaking machine whose processing devices must move a greater mass with each contact with the crop the greater the area density is to the extent all other operating parameters are maintained. This can be mitigated by reducing travel speed, although this is only useful to a limited extent in order to save time. The drive speed of the processing devices can also be increased. It would be advantageous to know the area density in advance in order to be able to make the appropriate settings. Apart from a rough estimate, however, there is often no information available thereon, especially as the area density within a parcel of land can vary locally.

### SUMMARY

An aspect of the present invention is to provide an improved, situation-appropriate setting of a cropmaking machine.

In an embodiment, the present invention provides a method for field processing which includes mowing, via a mowing machine comprising at least one mower, a crop within a processing area so as to provide a mown crop. At least one mowing parameter is determined for each position of a plurality of positions within the processing area. The at least one mowing parameter comprises a mower parameter which relates to the at least one mower and which is associated with an area density of the crop. The mown crop is processed via a cropmaking machine which comprises at least one processing device. At least one cropmaking parameter which characterizes an operation of the cropmaking machine is set as a function of a position of the cropmaking machine. The at least one mowing parameter is determined for the position.

### BRIEF DESCRIPTION OF THE DRAWINGS

The present invention is described in greater detail below on the basis of embodiments and of the drawings in which:

FIG. 1 shows a schematic top view of a mowing machine according to the present invention and a cropmaking machine;

FIG. 2 shows a schematic top view of a processing area with the mowing machine and the cropmaking machine from FIG. 1; and

FIG. 3 shows a flow chart of a method according to the present invention.

### DETAILED DESCRIPTION

The present invention provides a method for field processing, wherein a mowing machine mows crops within a processing area via at least one mower, wherein at least one mowing parameter is determined for each position of a plurality of positions within the processing area, and wherein at least one mowing parameter is a mower parameter which relates to at least one mower and which is associated with an area density of the crops.

The processing area can, for example, be a field, meadow or the like. It can be a land parcel or part of a land parcel. This is generally the area in which the method according to the present invention is carried out.

The mowing machine can be any type of agricultural machine which is designed to mow crops. This also expressly includes agricultural machines to which different attachments can be coupled, whereby at least one mower is designed as such an attachment. This means that the actual vehicle body of the agricultural machine need not be explicitly set up for mowing. The mowing machine can have its own drive, in particular its own power drive. The mowing machine can alternatively be set up to couple in an external drive power. The agricultural machine may also have its own chassis, but no power drive, thereby requiring the agricultural machine to be pulled by a tractor. However, for the purposes of the present invention, the combination, including the tractor, can also be understood in its entirety as a “mowing machine”. The mowing machine has at least one mowing unit or possibly a plurality of mowing units. Each mower is used to mow crops, i.e., to cut crops from a stock. The term “cutting” is to be interpreted broadly in this context and does not necessarily imply that a blade acts on the crop. It rather generally refers to the cutting off of a part, usually the predominant part of the plant, while a part including the root is typically left standing. The mowing machine therefore mows the crop, leaving the mowed crop on the ground.

At least one mowing parameter is determined for each position of a plurality of positions within the processing area. The respective position is a position of at least one part of the mowing machine, for example, the position of a mower, which is temporarily taken up during mowing. The position can be determined and specified with varying degrees of accuracy. The accuracy can be between a few centimeters and a few meters depending on the design of the method. This can typically be a two-dimensional position specification, however, a third dimension could also be included. A large number of positions are included. Two positions can be clearly spaced apart, however, it would also be conceivable for a number of positions to merge quasi-continuously into one another. At least one mowing parameter is determined for each of the mowing positions. The determined mowing parameter can be saved together with the associated position. It is also explicitly possible to determine a mowing parameter for a position by interpolation between neighboring positions for which the mowing parameter is known.

The respective mowing parameter can be determined at least partially by the mowing machine. The mowing machine can, for example, measure a value that is either a mowing parameter itself or on which a mowing parameter is based. A mowing parameter can be determined from one or more measured values, for example, by calculation or using a look-up table. The determination can, however, also be carried out at least partially outside the mowing machine, for example, by transmitting at least one measured value wirelessly or by wire to an external evaluation unit, which then determines the mowing parameter. A mowing parameter can generally be related to and/or describe the operation and/or condition of the mowing machine. At least one mowing parameter is a mower parameter which relates to at least one mower and which is associated with an area density of the crop. The mower parameter relates to the respective mower and can be related to and/or describe the operation and/or condition of the mower. If the mower parameter is determined by measurement, this measurement can, for example, be carried out on the mower.

The mower parameter is related to the area density of the crop. In this context, the area density can, for example, be defined as the quotient of the mass of the crop and the area on which the crop is standing. This area density is generally not constant but depends on the position. A crop with a high area density is also referred to as a “heavy crop”, while one with a low area density is referred to as a “light crop”. At a given travel speed of the mowing machine, a high area density leads to a high mass flow rate of the mowed crop through the mower, while a low area density leads to a low mass flow rate. The area density can depend on various factors that can vary within the processing area, for example, the type and size of individual plants, their distance from each other, and their moisture content. It can be said that the mower parameter is at least partially influenced by the area density. It is also possible, however, that other variables also have an influence on the mower parameter. If the influence of other variables is either taken into account or can be disregarded, for example, because other variables do not change, the area density can be concluded from the mower parameter. This means that the area density can be implicitly known.

According to the present invention, a cropmaking machine processes the mowed crop subsequently in time with at least one processing device, wherein at least one cropmaking parameter, which characterizes the operation of the cropmaking machine, is set as a function of a position of the cropmaking machine and the at least one mowing parameter determined for this position.

The cropmaking machine is designed to process crops lying on the ground, in particular stalks such as grass or hay, via at least one processing device. The crop is picked up, moved, and again deposited, whereby the position of a particular piece of crop generally changes. This allows the crop to be turned and/or distributed. It is also possible, however, for the cropmaking machine to combine the crop into a swath. The cropmaking machine can in particular be designed as a turner, tedder or swather. The at least one processing device is either directly or indirectly connected to a frame of the cropmaking machine. It forms the part of the cropmaking machine that actively interacts with the crop. The at least one processing device can, for example, be arranged movably on the frame and can in particular be driven relative to the frame. The cropmaking machine can have its own chassis and power drive. The cropmaking machine can, however, also be designed without its own power drive, for example, to be pulled by a tractor. The cropmaking machine can also possibly be carried as an attachment by a tractor. The tractor including the attachment or the combination of a tractor and a towed machine as a whole can, however, also be regarded as a “cropmaking machine”. “Subsequent in time” means that the processing (i.e., cropmaking) of the crop by the cropmaking machine takes place after the crop has been mowed. This could be immediately after mowing, with the cropmaking machine following the mowing machine at a certain distance. It could, however, also occur hours or days after mowing.

The at least one cropmaking parameter characterizes the operation of the cropmaking machine. It can also be said that at least one aspect of the operation of the cropmaking machine can be described by the respective cropmaking parameter. It can also be described as an operating parameter of the cropmaking machine. This cropmaking parameter can correspond to an adjustable operating size, but it can also be composed of a plurality of such operating factors, for example, as their product, quotient, sum or difference. The cropmaking parameter is generally not kept constant but is set depending on a position of the cropmaking machine and the at least one mowing parameter determined for this position. If the cropmaking parameter is composed of several operating factors, this can include a setting of one or more operating factors. It can be said that the cropmaking parameter is set depending on the position. The current position of the cropmaking machine is determined and the at least one mowing parameter that was determined for this position is used to set the at least one cropmaking parameter. This takes advantage of the fact that at least one mowing parameter is a mower parameter which, as described above, is at least partially dependent on the area density. Under certain circumstances, this can also apply to a mowing parameter that is not a mower parameter. It is therefore possible to draw conclusions about the area density at least under certain conditions. The optimal setting of the cropmaking machine, represented by at least one cropmaking parameter, in turn generally depends on the area density. Regardless of whether an area density is actually determined, the at least one cropmaking parameter can therefore be set depending on the position and depending on the at least one mowing parameter in order to optimize the cropmaking process.

The term “parameter”, for example, “cropmaking parameter” or “mowing parameter”, here and in the following in particular refers to a simple numerical value, which may be associated with a unit such as Newton, Watt or the like. A parameter could more generally also be a multidimensional quantity, for example, a vector or a matrix.

At least one cropmaking parameter can, for example, be related to a drive speed of a processing device and/or a cropmaking travel speed of the cropmaking machine. This includes the possibility that the cropmaking parameter is identical to the drive speed or to the cropmaking travel speed. However, it can also be a cropmaking parameter that can be calculated from one or both of the variables mentioned. In this context, “travel speed” refers to the movement speed in relation to the ground, which in the case of a towed or carried cropmaking machine corresponds to the speed of the tractor. “Drive speed” refers to any quantity that describes how fast the processing device moves relative to the frame of the cropmaking machine or how fast it is driven. This could, for example, be a speed, an angular velocity, a frequency, or a rotational speed.

A cropmaking parameter can, for example, correspond to a ratio between the drive speed of a processing device and the cropmaking travel speed. The ratio can also be expressed as a quotient. This ratio can in particular be used to adapt to different area densities. The travel speed determines how much area the cropmaking machine processes per unit of time. The area density in turn determines how much mass of crop is to be processed per area unit. Although it is not possible to specify a generally valid optimum value or limit value in this respect, it is best for the cropmaking machine to process neither too much nor too little mass per unit of time. This consideration also applies to the mass of crop that the processing device must move each time it comes into contact with the crop. Increasing (or decreasing) the cropmaking travel speed at a certain drive speed of the processing device results in the processing device having to move a larger (or smaller) mass each time it comes into contact with the crop. Increasing (or decreasing) the drive speed at a certain cropmaking travel speed means that the processing device must move a smaller (or larger) mass at each contact. The cropmaking process can therefore be optimized within certain limits by adjusting the ratio between drive speed and cropmaking travel speed to the area density. In this embodiment, this is done indirectly by adjusting the ratio to the at least one mowing parameter.

Different types of cropmaking machines can in principle be used in the process according to the present invention, for example, rotary tedders, drum turners, chain rake turners, star wheel rakes, comb rakes, belt rakes, or the like. The cropmaking machine can, for example, have at least one rake rotor as a processing device which is operated at a gyro rotational speed as the drive speed. It may in this case be a rotary tedder or rotary swather. At least two rake rotors are advantageously provided. The basic structure and function of a rotary tedder or rotary swather are well known and are therefore not discussed in detail. Each rake rotor forms a processing device which interacts with the crop via a number of tine arms. In the case of a rotary swather, two rake rotors, which are driven in opposite directions, can deposit the crop in a deposit area that is at least partially arranged between the two rake rotors. The movement of a rake rotor can be fully characterized by a gyro rotational speed. This naturally corresponds to an angular velocity of the rake rotor. In combination with the above embodiment, it is possible to adapt a ratio between gyro rotational speed and cropmaking travel speed to the position-dependent mowing parameter(s).

One embodiment provides that, in addition to the at least one mower parameter, a mowing machine travel speed of the mowing machine is determined as a mowing parameter and the at least one cropmaking parameter is determined as a function of the mowing machine travel speed determined for the respective position. This is based on the consideration that the mass flow rate, i.e., the mass of crop processed by the mower per unit of time, depends on the area density but also on the mowing machine travel speed. At higher mowing machine travel speed, the mowing machine processes a larger area per unit of time, which should be taken into account when drawing conclusions about area density. The mowing machine travel speed can only be omitted if it can be assumed to be almost constant within the entire processing area. This is, however, unrealistic for a typical processing operation. If a mower parameter is determined that allows a conclusion to be drawn on the mass flow rate, this can be divided by the mowing machine travel speed to obtain a measure of the area density.

If the cropmaking machine leaves the processing area shortly after the mowing machine, it can be assumed that the crop has not changed significantly in the meantime. Depending on the type of crop, it is likely that parts of the crop will be caught by the mowing machine but not by the cropmaking machine. This can, for example, be plant parts that are close to the ground and cannot be detected. Apart therefrom, it is advantageous if a drying process that takes place between mowing and cropmaking is taken into account when determining the cropmaking parameter. This applies in particular if there is a longer period between mowing and cropmaking, for example, at least one day. The drying process in particular causes the crop to lose mass. This reduces the area density during the cropmaking process compared to the mowing process. This can be taken into account when setting the respective cropmaking parameter. Weather data relating to the processing area can in particular also be taken into account when considering the drying process.

An embodiment of the present invention provides that at least one mower with a mowing unit mows the crop, processes it with a processor and deposits it again after processing, wherein the at least one mower parameter relates to the processor. The mowing unit can, for example, be designed as a cutter bar which can cut the crop according to the scissor cut principle, or via rotating mowing discs. Other functional principles known in the state of the art are also conceivable. The crop is not deposited immediately after cropping but is first handed over to the processor. This processor, which can also be called a conditioner, can crush and/or bend the crop, in particular to damage a wax film that hinders moisture exchange between the crop and its environment. The processed crop can therefore dry more quickly in dry weather conditions. Without being limited thereto, the processor can have a plurality of rollers between which the crop is squeezed, or a rotor that can be driven in rotation which throws the crop against a fixed comb. This embodiment is based on the consideration that the work of the mowing unit is largely independent of how large and massive the individual plant is, but mainly of how many plants are cut per unit of time. This allows at best limited conclusions to be drawn about the area density. The processor interacts with the separated plant (or the separated part of the plant) as a whole. The processing is therefore more closely related to the area density.

The present invention also provides a method in which at least one mower with a mowing unit mows the crop, processes it with a processor, and deposits it again after processing, wherein the at least one mower parameter relates to the processor.

At least one mower parameter can, for example, be related to a power input of the processor, wherein a torque of a drive shaft of the processor can, for example, be measured to determine this mower parameter. The respective mower parameter can correspond to the power input, it is also possible, however, that the power input depends on this mower parameter, for example, in combination with other parameters. The power input of the processor is related to the area density. The power input can in particular be proportional to the area density for a given mowing machine travel speed. Other more complicated relationships are, however, also possible. It can typically be assumed that the power input is a monotonically increasing function of the mass of crop passing through the processor per unit of time. The power input can be measured in different ways. The drive power on some mowers is coupled into the processor via a drive shaft. The power input in this case is the product of the rotational speed of the drive shaft and the torque acting thereon. To determine the drive power, it is therefore useful to measure the torque in the drive shaft, which can also be referred to as the processor torque. This can be done using any measurement technology, for example, using a torque sensor that is assigned to the drive shaft.

Particularly in the above-mentioned embodiment, but not only in connection therewith, a drive speed of the processor can, for example, be detected to determine a mower parameter. Again, “drive speed” can refer to any quantity that describes how fast the processor is driven or how fast its moving components move relative to a frame of the mower. This could, for example, be a speed, an angular velocity, a frequency, or a rotational speed. A rotational speed can in particular be detected, for example, the rotational speed of the above-mentioned drive shaft or the rotational speed of a processor shaft mentioned below. A higher drive speed has the qualitative effect that there is less crop in the processor at any given time in that the crop is fed through the processor more quickly.

In an embodiment of the present invention, a vibration movement of at least one element of the processor can, for example, be detected by sensors to determine a mower parameter. The vibration movement is generally an oscillating movement, whereby in particular a translational oscillating movement can be detected, although a torsional oscillation could also be taken into account. The oscillating movement usually contains different frequencies and can therefore be characterized by a frequency spectrum. In this embodiment, it is possible that only part of the frequency spectrum is observed. Frequencies that are considered irrelevant could be removed, for example, using a band filter. The basic consideration in this embodiment is that the vibration movement is at least partially based on an interaction between the processor and the processed crop. The mass flow rate, i.e., the mass of crop passing through the processor per unit of time, as well as the density of the crop flow (i.e., the amount of crop in the processor at a given moment) can therefore influence the vibration movement, especially its amplitude. It can in particular be observed in many cases that the intensity of the interaction increases with a higher mass flow rate and thus a stronger vibration movement occurs at least in some frequency ranges. It is possible to determine the area density from the recorded vibration movement, for example, in combination with the drive speed of the processor and the mowing machine travel speed. The exact correlation depends on many factors and can in particular depend on the design of the processor. It can, however, be determined experimentally for a certain type of processor, for example, by a series of measurements using known area densities.

It is possible, for example, to detect the vibration movement via a position sensor that detects the time-varying position of an element of the processor. A mower parameter can, for example, be determined at least partially based on an acceleration associated with the vibration movement. The oscillating vibration movement can be described by the time-varying position, but also by a time-varying speed (i.e., the first-time derivative of the position) and a time-varying acceleration (i.e., the second-time derivative of the position). This acceleration, which is associated with the vibration movement, can be detected by acceleration sensors known in the state of the art, in particular by sensors whose measuring principle is based on the detection of an inertial force.

The acceleration is advantageously measured in the area of a bearing of a rotatably driven processor shaft. The processor shaft is a moving part of the processor which can be at least indirectly coupled to the above-mentioned drive shaft. According to one design, the drive force is coupled in on one side of the processor shaft, while the processor shaft is passively mounted on the opposite side. The processor shaft is mounted on a frame of the mower so that it can rotate around a shaft axis. The acceleration can be measured in the area of one of the bearings. The acceleration of the processor shaft itself or the acceleration of neighboring areas of the frame can be detected, for example, a fixed part of the bearing. It would be conceivable to measure the acceleration in the axial direction in relation to the shaft axis. The acceleration can, for example, be measured perpendicular to a shaft axis of the processor shaft. It can also be said that a radial acceleration with respect to the shaft axis is detected at least in some embodiments.

At least one mower parameter is advantageously determined based on time averaging. This means that no instantaneous value is considered, but rather a certain time interval within which a value is averaged. The respective time interval should generally be short enough so that the position of the mowing machine does not change too much during this time. Different types of averaging are possible. A mower parameter can in particular correspond to a time-averaged absolute value of the acceleration, whereby one can also speak of an absolute mean value. This means that for a certain time interval, it is not the signed acceleration that is considered, but its absolute value, which is non-negative by definition. This absolute value is averaged over time, for example, by integrating it over the time interval and dividing the integrated value by the length of the time interval. The exact relationship between the averaged absolute amount and the area density can in turn be determined experimentally for the respective type of mowing machine or the respective type of processor. A dependency on the drive speed of the processor can here again be taken into account.

The at least one mowing parameter can advantageously be used to determine a position-dependent area density of the crop within the processing area. For the position-dependent setting of the at least one cropmaking parameter, it is not necessary to explicitly determine the area density, although this is a possible intermediate step. It may be desirable for other reasons, however, to determine the area density explicitly. This can be used, for example, to determine in which parts of the processing area having poorer soil quality may result in a lower area density. This knowledge could be used in the future to fertilize a particular area more than other areas. Other measures are also conceivable in response to observed differences in area density.

The present invention also provides a mowing machine for use in a method according to the present invention. The mowing machine has at least one mower for mowing crops, wherein the mowing machine is set up to mow crops within a processing area via the at least one mower and to determine at least one mowing machine parameter for each position of a plurality of positions within the processing area, wherein at least one mowing machine parameter is a mower parameter which relates to at least one mower and which is associated with an area density of the crop. At least one mower can, for example, have a mowing unit for mowing crops and a processor for processing crops, and the at least one mower parameter relates to the processor.

Further embodiments of the mowing machine according to the present invention correspond to those of the method according to the present invention. The mowing machine can in particular be set up to detect a vibration movement of at least one element of the processor by sensors in order to determine a mower parameter. The mower can have an acceleration sensor that is set up to detect an acceleration associated with the vibration movement.

The present invention is described below with reference to drawings. The drawings are thereby merely exemplary and do not limit the general idea of the present invention.

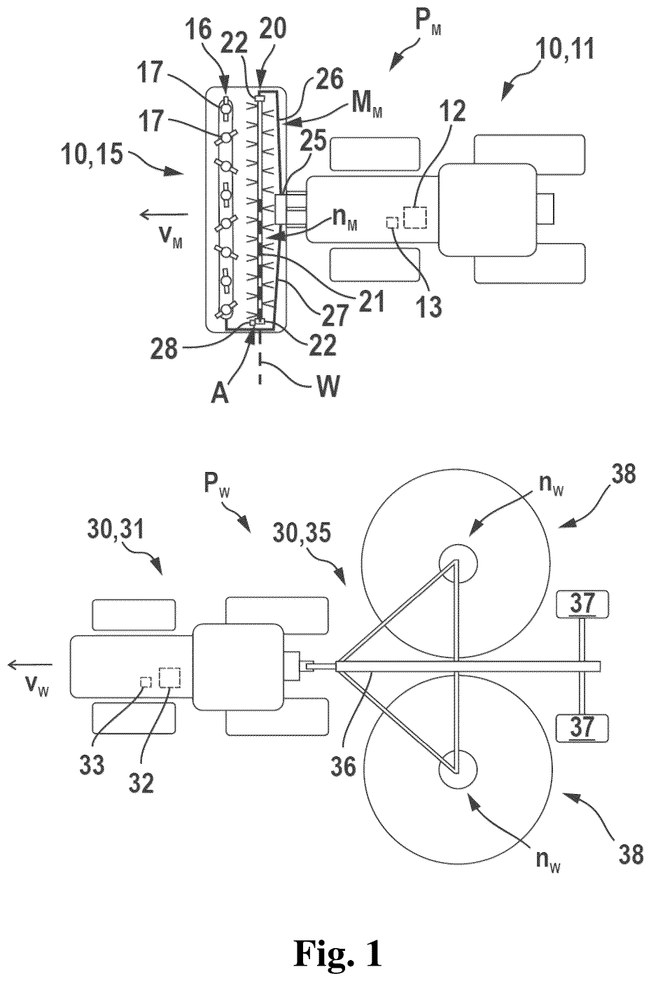

FIG. 1 shows a mowing machine 10 according to the present invention, which in this case is formed by a first tractor 11 with a mower 15 attached to the front. The first tractor 11 has a first control unit 12 and a first wireless communication interface 13. The mower 15 has a mowing unit 16, which can also be referred to as a cutter bar. The mowing unit 16 has a plurality of rotatably drivable mowing discs 17. These are connected via a drive shaft of the mowing unit 27 to a transfer case 25, which in turn is connected to a PTO shaft of the first tractor 11 (which is not shown in the drawings). The mowing unit 16 is set up to mow crops, for example, stalks, from a stock 2, cutting each plant of the stock 2 so that a part remains in the ground with the root. The mower 15 also has a processor 20, which in this case is designed as a tine processor. A plurality of tines (without reference signs) are connected to a processor shaft 21, which is rotatably mounted about a shaft axis W via two bearings 22. The processor shaft 21 is driven by a drive shaft of the processor 26, which is also connected to the transfer case 25. During operation of the mowing machine 10, a rotational speed of the processor shaft 21 can be set at least partially independently of a mowing machine travel speed v_{M} of the mowing machine 10. This allows a ratio R between the rotational speed of the processor n_{M} and the mowing machine travel speed v_{M} to be set. The corresponding settings can be checked by the first control unit 12. A processor torque M_{M} in the drive shaft of the processor 26 can be measured via a sensor (not here shown). A measurement could alternatively also be carried out on the processor shaft 21 itself. An acceleration sensor 28 is arranged on the bearing 22 opposite to the drive shaft of the processor 26 which detects an acceleration in the area of the bearing 22. This allows a vibration movement in the area of the bearing 22 to be monitored. The corresponding measured value is received by the first control unit 12. This forms the absolute value and averages it over a time interval, which can, for example, be between 1 and 5 seconds. This results in an absolute mean value A. The first control unit 12 can also determine a mowing machine position P_{M} for which it can use various sensors (not shown in the drawings). The mowing machine position P_{M} could, for example, be determined using RTK (real time kinematics), whereby GNSS is used on the one hand and signals from a terrestrial base station with GNSS receiver are evaluated on the other.

A cropmaking machine 30 is also shown in FIG. 1 which in this example is designed as a combination of a second tractor 31 and an attached swather 35. The second tractor 31 has a second control unit 32 and a second wireless communication interface 33. The second wireless communication interface 33 is designed for wireless communication with the first wireless communication interface 13. The swather 35 has a frame 36 which is supported by a chassis 37. The frame 36 has two extension arms (without reference signs), on each of which a rake rotor 38 is arranged. The respective rake rotor 38 forms a processing device of the swather 35 with which crop lying on the ground can be picked up and deposited in a depositing area so that a swath (not shown) is formed. The rake rotors 38 are shown purely schematically. Each rake rotor 38 in fact has a plurality of tine arms to which tines are in turn attached. During operation, a rotational speed of the rake rotor n_{W} can be set at least partially independently of a travel speed of the cropmaking machine v_{W} via the second control unit 32. This means that a ratio R between the rotational speed of the rake rotor n_{W} and the travel speed of the cropmaking machine v_{W} can be set. The second control unit 32 can determine a cropmaking machine position P_{W}, for which in turn various sensors (not shown in the drawings) can be used.

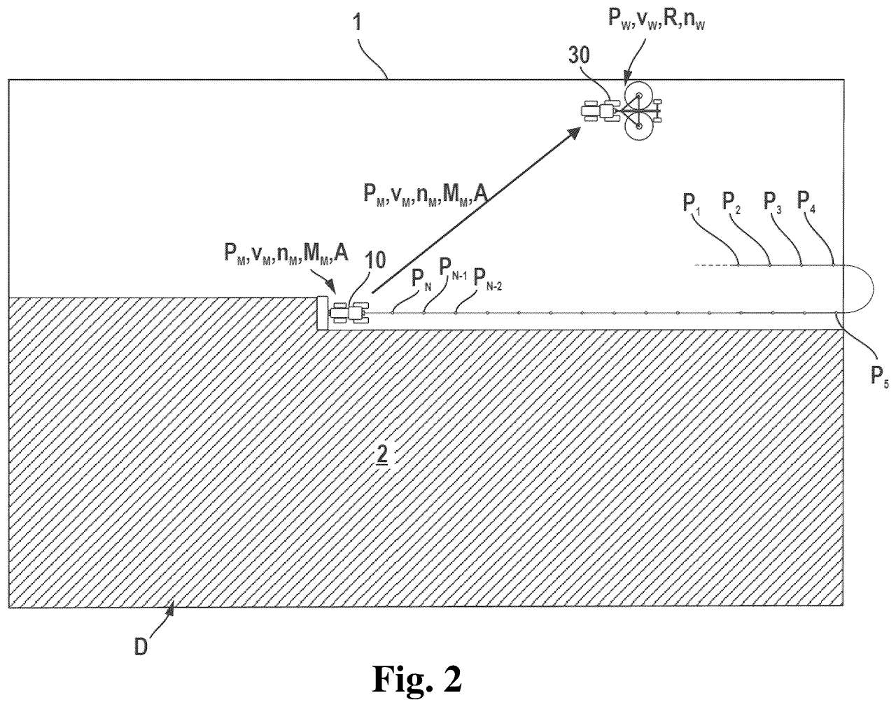

When processing a processing area 1, which is shown schematically in FIG. 2, the mowing machine 10 gradually mows the crop in the stock 2, which has a generally location-dependent, i.e., non-constant, area density D. The mowing machine 10 follows a route that is normally planned in advance, in which it passes through a number of positions P₁-P_{N} one after the other. It should be understood that, for reasons of clarity, only part of the route is shown in FIG. 2 and the first position P₁ marked there does not represent the actual start of the route. The crop cut by the mowing unit 16 and crushed and/or broken by the processor 20 remains on the ground behind the mowing machine 10. It is processed by the cropmaking machine 30 in a subsequent cropmaking process. The latter travels along the part of the processing area 1 already processed by the mowing machine 10, whereby it can use the same route as the mowing machine 10 or a different route. In order to achieve optimum adaptation to the area density D, which varies depending on the position even after mowing, the cropmaking machine 30 evaluates information received from the mowing machine 10 and uses this to set an optimum ratio R.

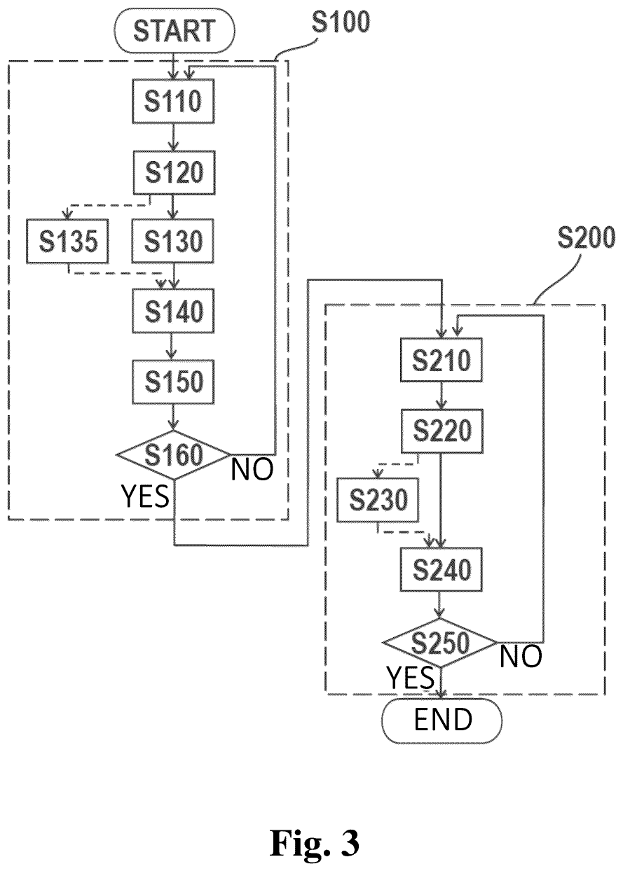

An example of a field processing method according to the present invention is explained with reference to the flow chart in FIG. 3. The flow chart shows a mowing process S100, which is carried out by the mowing machine 10, and a subsequent cropmaking process S200, which is carried out by the cropmaking machine 30. Deviating from this illustration, however, it is expressly possible that the mowing process S100 and the cropmaking process S200 partially overlap in time.

In a first step S110, the mowing machine 10 mows the crop, which is processed by the processor 20, and moves from one position P₁-P_{N} to the next. In a further step S120, which can also take place at the same time as the first step S110, the first control unit 12 determines several mowing parameters, namely, the mowing machine position P_{M}, the mowing machine travel speed v_{M}, and the rotational speed of the processor n_{M}. In a further step S130, the absolute mean value A is determined as a further mowing parameter. The processor torque M_{M} could alternatively be determined in a step S135. The absolute mean value A, the processor torque M_{M}, and the rotational speed of the processor n_{M} represent mower parameters that affect the mower 15.

Using the mowing machine travel speed v_{M}, the rotational speed of the processor n_{M}, and either the absolute mean value A or the processor torque M_{M}, the area density D for the current position is determined in a further step S140. A look-up table stored in the first control unit 12, which was created via a series of measurements using an identical mower 15, can be used for this purpose. In a further step S150, the current mowing machine position P_{M}, the mowing machine speed V_{M}, the rotational speed of the processor n_{M}, and either the absolute mean value A or the processor torque M_{M} are transmitted via the first wireless communication interface 13. The transmission can be received directly by the second wireless communication interface 33. In addition or alternatively, another communication interface (not shown in the drawings) can also receive the specified values mentioned. This can be assigned to a stationary farm management system, for example, which stores the values. Optionally, the determined area density D can also be transmitted.

In a further step S160, the system checks whether the route has already been completed, i.e., whether the last position P₁-P_{N} has been reached. If not, the procedure returns to step S110. If the last position P₁-P_{N} has been reached, the process leaves the mowing process S100 and enters the cropmaking process S200. In a step S210, the cropmaking machine 30 processes the crop lying on the ground as it moves to the next position P₁-P_{N}. In a further step S220, which can also take place at the same time as the aforementioned step S210, the cropmaking machine position P_{W} and the travel speed of the cropmaking machine v_{W} are determined. If a significant period of time has elapsed since mowing, a drying process can be taken into account in step S230, as a result of which the area density D may have decreased in the meantime. Then, in a further step S240, an optimum ratio R and the resulting rotational speed of the rake rotor n_{W} are determined and set as cropmaking parameters. In step S260 it is checked whether the last position P₁-P_{N} has already been reached. If not, the procedure returns to step S210. If yes, the procedure ends.

In this example, the cropmaking parameters n_{W} and R are determined internally within the cropmaking machine 30. It would also be possible for these to be determined externally, for example, within the above-mentioned farm management system or within the mowing machine 10.

The present invention is not limited to embodiments described herein; reference should be had to the appended claims.

### LIST OF REFERENCE CHARACTERS

1 processing area
2 stock
10 mowing machine
11 first tractor
12 first control unit
13 first wireless communication interface
15 mower
16 mowing unit
17 mowing disc
20 processor
21 processor shaft
22 bearing
25 transfer case
26 drive shaft of the processor
27 drive shaft of the mowing unit
28 acceleration sensor
30 cropmaking machine
31 second tractor
32 second control unit
33 second wireless communication interface
35 swather
36 frame
37 chassis
38 rake rotor
A absolute mean value
D area density
M_{M} processor torque
n_{M} rotational speed of the processor
n_{W} rotational speed of the rake rotor
P_{1-N} positions of mowing machine
P_{M} mowing machine position
P_{W} cropmaking machine position
R ratio between the rotational speed of the rake rotor n_{W} and the travel speed of the cropmaking machine v_{W}
v_{M} mowing machine travel speed
v_{W} travel speed of the cropmaking machine
W shaft axis

What is claimed is:

1-15. (canceled)

16: A method for field processing comprising:
mowing, via a mowing machine comprising at least one mower, a crop within a processing area so as to provide a mown crop;
determining, for each position of a plurality of positions within the processing area, at least one mowing parameter, wherein the at least one mowing parameter comprises a mower parameter which relates to the at least one mower and which is associated with an area density of the crop; and then
processing the mown crop via a cropmaking machine which comprises at least one processing device,
wherein,
at least one cropmaking parameter which characterizes an operation of the cropmaking machine is set as a function of a position of the cropmaking machine, and
the at least one mowing parameter is determined for the position.

17: The method as recited in claim 16, wherein the at least one cropmaking parameter is related to a drive speed of the at least one processing device and/or to a cropmaking travel speed of the cropmaking machine.

18: The method as recited in claim 17, wherein the cropmaking machine comprises, as the at least one processing device, at least one rake rotor which is operated at a gyro rotational speed as the drive speed.

19: The method as recited in claim 16, wherein the at least one cropmaking parameter corresponds to a ratio between a drive speed of a processor and a travel speed of the cropmaking machine.

20: The method as recited in claim 16, wherein,
the at least one mowing parameter further comprises a mowing machine travel speed of the mower, and
the at least one cropmaking parameter is further set as a function of the mowing machine travel speed as determined for a respective position.

21: The method as recited in claim 16, wherein, in setting the at least one cropmaking parameter, a drying process which has taken place between the mowing and the processing, is taken into account.

22: The method as recited in claim 16, wherein,
the at least one mower comprises a mowing unit and a processor,
the mowing unit of the at least one mower preforms the mowing of the crop so as to provide the mown crop,
the processor of the at least one mower performs the processing of the mown crop and then deposits the processed mown crop, and
the at least one mower parameter relates to the processor.

23: The method as recited in claim 22, wherein,
the processor comprises a drive shaft, and
at least one mower parameter is associated with a power input of the processor.

24: The method as recited in claim 23, further comprising:
measuring a torque of the drive shaft of the processor to determine the at least one mower parameter.

25: The method as recited in claim 22, further comprising:
detecting a drive speed of the processor in order to determine the at least one mower parameter.

26: The method as recited in claim 22, further comprising:
detecting, via at least one sensor, a vibration movement of at least one element of the processor in order to determine the at least one mower parameter.

27: The method as recited in claim 26, wherein the at least one mower parameter is determined at least partially based on an acceleration which is associated with the vibration movement.

28: The method as recited in claim 27, wherein,
the at least one mower further comprises a rotatably driven processor shaft which comprises a bearing, and
the acceleration is measured in a region of the bearing of the rotatably driven processor shaft.

29: The method as recited in claim 28, wherein,
the rotatably driven processor shaft has a shaft axis, and
the acceleration measured in the region of the bearing of the rotatably driven processor shaft is measured perpendicular to a shaft axis of the rotatably driven processor shaft.

30: The method as recited in claim 27, wherein the at least one mower parameter is determined based on a time averaging.

31: The method as recited in claim 30, wherein the time averaging corresponds to a time-averaged absolute value of the acceleration.

32: The method as recited in claim 16, wherein the at least one mowing parameter is used to determine a position-dependent area density of the crop within the processing area.

33: A mowing machine which is used in the method as recited in claim 16, the mowing machine comprising:
at least one mower which is configured to mow a crop,
wherein,
the mowing machine is set up to mow the crop within a processing area via the at least one mower and to determine at least one mowing parameter for each position of a plurality of positions within the processing area, and
the at least one mowing parameter is a mower parameter which relates to the at least one mower and which is associated with an area density of the crop.

34: The mowing machine as recited in claim 33, wherein,
the least one mower comprises a mowing unit for mowing the crop and a processor for processing the crop, and
the at least one mower parameter relates to the processor.
